(19) United States
(12) Patent Application Publication
(10) Pub. No.: US 2002/0148325 A1
(43) Pub. Date: Oct. 17, 2002

(54) Semi-solid formed, low elongation aluminum alloy connecting rod

(76) Inventor: S. Craig Bergsma, The Dalles, OR (US)

Correspondence Address: ANDREW ALEXANDER & ASSOCIATES, 3124 KIPP AVENUE, P.O. BOX 2038, LOWER BURRELL, PA, 15068, US

(21) Appl. No.: 09/834,189

(22) Filed: Apr. 13, 2001

(51) Int. Cl. F16C 7/02

(52) U.S. Cl. 74/593; 74/579 E

(57) ABSTRACT

A method for forming a remateable cracked aluminum base alloy connecting rod using a semi-solid aluminum alloy processing to produce a connecting rod having a globular microstructure contained in a lower melting eutectic with improved properties.

### BACKGROUND OF THE INVENTION

This invention relates to a low elongation aluminum alloy member and more particularly it relates to low elongation aluminum alloy members formed in a semi-solid condition into shaped aluminum alloy members such as internal combustion engine connecting rods and caps therefor. Further, the invention relates to the production of connecting rods having split bearing assemblies and matched mating surfaces at the large bore or circumferential opposite ends.

Most aluminum alloys solidify to form a dendritic microstructure. Such structure requires forces such as forging type forces to shape the solidified alloy into a high strength member suitable for use, for example, as a connecting rod in an internal combustion engine. If the connecting rod is cast into shape without further work then it usually has low strength and is not suitable for many applications where strength is important. If the high strength members are produced utilizing powder metallurgy techniques, a green compact must be first formed and then the compact sintered to form the desired part.

These techniques are used to form connecting rods for internal combustion engines. The connecting rod has three parts, namely, a small end or terminal portion with a small bearing hole, a large end with a large bearing opening and a rod portion connecting the small bearing to the large bearing. The connecting rod is comprised of two members including a semi-circular end cap which forms approximately half the large bearing opening. The end cap is fastened to a mating surface formed as part of the connecting rod. The small end is an integral part of the connecting rod. The end cap is required to fit the connecting rod to the crank of the internal combustion engine.

Conventionally, the connecting rod was fabricated in two parts comprised of the end cap and connecting rod. However, considerable difficulty was experienced in precisely mating the end cap to the connecting rod to form the large bearing opening. To overcome the problem of matching the end cap to the mating surface, the end cap is forged against or cracked from the large bearing surface utilizing crack initiating indents to promote a cracking plane to provide an exactly remateable end cap surface which is employed in sintered powder or forged aluminum connecting rods. For example, U.S. Pat. No. 5,566,449 discloses a connecting rod as a shaft clamping member and includes a rod member and cap, each of which has mating faces at circumferentially opposite ends of a semi-circular recess and which are fastened to each other by bolts by matching the opposed mating faces to each other to define a crank pin hole by the two semi-circular recesses. The rod member and the cap are forgings formed from an aluminum alloy and simultaneously produced by forging powder preforms of the rod member and cap in a cavity having the desired shape of the connecting rod. After forging, the opposed mating faces have an infinite number of recesses and projections which are formed from the flow of the material during the forging and which are in a matched and fitted relation to each other.

U.S. Pat. Nos. 5,353,500; 5,131,577; 5,109,605; 5,105,538; 4,993,134 and 4,936,163 disclose a method of making a connecting rod for attachment to a bearing journal by separation of parts of the connecting rod, including: (a) forging a powder metal sintered preform to provide a one-piece connecting rod having an annular wall defining a crank opening with a center axis and with stress risers for establishing a cracking plane that extends across the crank opening; (b) providing access for a compression coupling across the cracking plane; (c) while at ambient conditions, applying tension substantially uniformly across the cracking plane to propogate fracture from the stress risers along the cracking plane and thereby separate the connecting rod into a cap and body with cracked surfaces; and (d) remating the cap and body by applying a compression coupling through the access to draw the cap and body together under guidance and with metal yielding pressure to effect substantially an exact rematch of the cracked surfaces. Control of the diametrical clearance between the bolt shanks and the bolt openings, of the bolts used as the compression coupling, promotes guidance needed to achieve such rematch. The cracking is effected in an improved manner by use of continuous pulling apart of the rod in a direction perpendicular to the cracking plane.

U. S. Pat. No. 4,860,419 discloses a method for making split bearing connecting rods, including steps wherein previously clamped body and cap portions are quickly forced apart longitudinally to cause fracture separation of both pairs of integral legs in a single motion while the cap and body are restrained from substantial relative rotation by a clamp of a fracture separation apparatus.

U.S. Pat. No. 4,569,109 discloses split bearing assemblies having separable bearing caps for both single applications, such as connecting rods, and multiple applications, such as engine crankshaft supports, together with methods and apparatus for making such assemblies by integrally forming the caps with the main body and separating them by fracture separation. A two step separation method is disclosed with bore starter notches and semicircular die expanders that minimize split plane and bore distortion.

U.S. Pat. No. 5,051,232 discloses that the separation of two or more forged powder metal components is facilitated by forming a compacted and sintered powder metal preform with at least one slit that separates the component pieces. An anti-bonding agent such as graphite is introduced into the slit and the preform is then forged to final shape. The anti-bonding agent prevents the complete bonding of the powder metal pieces to each other thereby facilitating separation of the pieces at the slit. This method is particularly suited for the manufacture of piston connecting rod assemblies of the type including a connecting rod and cap.

U.S. Pat. No. 5,722,036 discloses a manufacturing process of a sintered connecting rod assembly comprising a first member with a projection and a second member with a concavity in which the first member and the second member are mated with each other by engaging the projection with the concavity. A powdered raw material is compacted into a first compact and a second compact for the first and second members, wherein the projection of the first compact has a width slightly larger than the width of the concavity of the second compact. Then the projection of the first compact is engaged with the concavity of the second compact to mate the first compact with the second compact, thereby the projection and the concavity are tightly pressed against each other. After sintering the mated first and second compacts, they are forced to release the projection from the concavity. The die for compacting the raw material has a whole cavity and a removable core for dividing the whole cavity into two cavities.

U.S. Pat. No. 3,994,054 discloses that the crankshaft bearing cap of a connecting rod is formed from a forged rod blank which includes an integral circular head having an internal bearing surface and have integrally formed interconnecting lug portions. The lug portions are provided with cracking openings aligned with and parallel to a cracking plane. Each of the openings is provided with a cracking notch or recess which extends downwardly from one side of the head between twenty and fifty percent of the opening length. The assembly is located on a lubricated supporting bed with the unnotched face resting on the supporting surface. Interconnected cracking pins with a suitable tapered configuration are simultaneously forced into the cracking holes with an impact type force. The tapered pins are interconnected to a common support equalizing the cracking impact pressure as the pins are moved into cracking openings. Each of the notches is formed with a V-shape with an inclusive angle of forty-five degrees and a relatively shallow depth of from 0.010 to 0.020 inches to define a sharp apex in the cracking plane. Suitably sized and circumferentially spaced radial lubrication holes in the cap provide improved lubrication and simplify the manufacturing process. The lubrication holes are spaced in accordance with the spacing of the needle roller bearings such that only one roller bearing is in aligned overlying relationship with each lubrication hole at any given instant.

U.S. Pat. No 4,693,139 discloses that the bearing half and bearing cap are integrally connected together by bolts, chamfers are made in the peripheral portions of the bearing half and the bearing cap facing their broken and divided surfaces. Such chamfers are made before the dividing of the larger diameter end portion and thus cause the breaking and dividing operation to be facilitated.

U.S. Pat. No. 4,836,044 discloses that a multi-piece connecting rod has the large eye end formed with a yoke receiving a bearing bracket supported on an angled wedge surface by an angled counter surface of a wedge. The wedge is carried by a pinlike bolt between legs of the yoke and includes a threaded portion engaged by the bolt for tightening the angled wedge surfaces to clamp the bearing bracket in position.

U.S. Pat. No. 5,594,187 discloses an apertured connecting rod having a stress riser crease formed in one side thrust surface made by forging a powder metal sintered preform with a V-shaped notch mold formed in a side face whereby the spaced surfaces defining the V-shaped notch are folded inwardly toward one another during forging to create a deep crease without any substantial width.

In spite of these disclosures, there is still a great need for an aluminum alloy based connecting rod having improved properties and fractured mating surfaces to provide exactly remateable end cap surfaces which can be fastened to form the large bearing opening in the connecting rod.

### SUMMARY OF THE INVENTION

It is an object of the invention to provide an improved aluminum base alloy connecting rod for an internal combustion engine.

It is another object of the invention to provide an aluminum base alloy for fabricating into articles such as connecting rods.

It is still another object of the invention to provide an aluminum base alloy for semi-solid forming into articles or members such as connecting rods.

Yet it is another object of the invention to provide a method for semi-solid forming an aluminum base alloy into connecting rods for internal combustion engines.

These and other objects will become apparent from a reading of the specification and claims appended hereto.

In accordance with these objects, there is provided a method of forming a remateable cracked aluminum base alloy connecting rod having improved strength. The method comprises the steps of providing a body of a semi-solid aluminum base alloy and a mold for a connecting rod, the mold defining a connecting rod having a large bore therein for use as a large bearing and a small bore for use as a small bearing, the bores connected by an arm member. The semi-solid aluminum base alloy is injected into the mold and cooled to solidify the semi-solid aluminum base alloy to provide the connecting rod having a globular microstructure in a lower melting eutectic matrix. The rod is aged or optionally solution heat treated in a temperature range of 800°-1000° F. for a period of 0.1 to 12 hours. Then the rod can be quenched and aged in a temperature range of 200-400° F. for a period of about 1-24 hours to provide an aged rod having improved strength. The rod may be aged to a T5 condition without the solution heat treatment. A cap portion is fractured along a fracture plane in a wall defining the large bore to provide a cap portion having cracked surfaces which permit substantially exactly rematching the cracked surfaces for securing the large bearing to a bearing surface of an engine crank. The invention also includes a semi-solid formed connecting rod having a globular microstructure contained in a lower melting eutectic phase.

### BRIEF DESCRIPTION OF THE DRAWINGS

FIG. 1 is a flow chart showing steps in the process of the invention.

FIG. 2 is a plan view of an aluminum base alloy connecting rod manufactured in accordance with the process of the invention.

FIG. 3 is a plan view showing the large end portion of the connecting rod after fracturing a cap portion from the large bore to provide substantially identical remateable surfaces.

FIG. 4 is a plan view showing the large end portion of the connecting rod showing the cap portion bolted to the connecting rod after being fractured across the fracture plane.

FIG. 5 is a plan view of a large bore illustrating the use of shell bearing when the cap portion is reconnected to the connecting rod.

### Detailed Description of the Preferred Embodiments

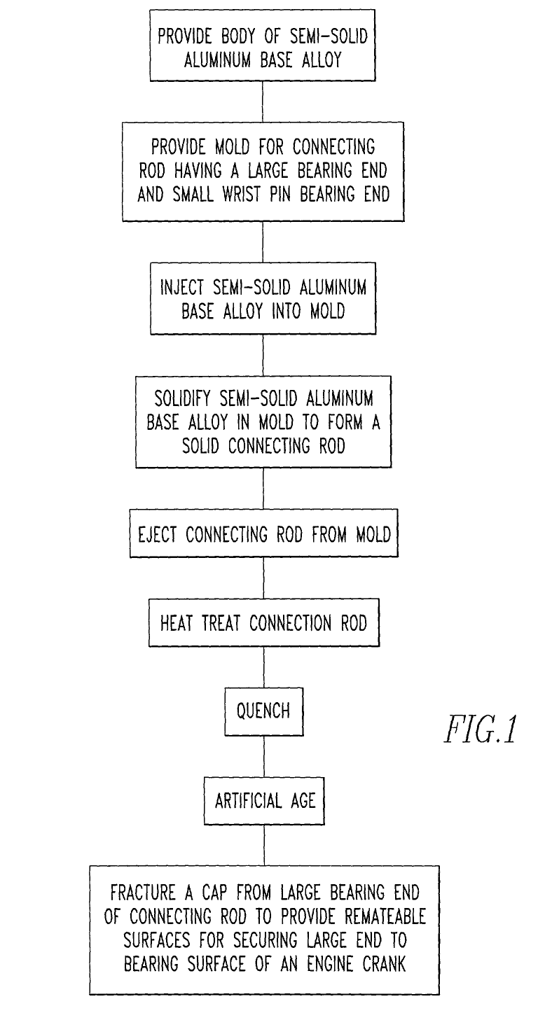

Referring now to FIG. 1, there is shown a flow chart illustrating steps which may be used in the invention. In FIG. 1, it will be seen that a body of semi-solid aluminum base alloy is provided for forming into a connecting rod. The semi-solid aluminum base alloy may be provided from a billet or sections of a billet which has been stirred during solidification or solidified in accordance with certain procedures to obtain the required globular grain structure. The sections of billet which are sufficient in size to provide one connecting rod are reheated to the semi-solid state required for forming into the connecting rod. This method is described in my U.S. Pat. Nos., 5,968,292; 5,846,350 and 5,571,346 incorporated herein by reference, as if specifically set forth.

The body of semi-solid aluminum alloy may be provided by another method. That is, a large body of molten aluminum base alloy is provided in sufficient quantity to produce a number of connecting rods. In this process, the body of suitable aluminum base alloy is cooled to a temperature where the semi-solid condition is obtained. Quantities of the semi-solid aluminum alloy are discharged therefrom for forming into the connecting rods. This process is described in U.S. Pat. No. 6,165,411, for example.

The semi-solid state is desirable because it is more easily formed into a shaped member. When a cast body is heated to a sufficient temperature, it transforms from a dendritic microstructure to a globular or spheroidal phase contained in a lower melting eutectic matrix and generally retains the same shape as the cast body. After transformation, the body is provided in a state resembling a thixotropic state which permits ease of forming by use of smaller forces than would be required for making a forging.

Referring again to FIG. 1, it will be seen that after having obtained the semisolid body of an aluminum base alloy, a mold the shape of the desired connecting rod is provided. The semi-solid aluminum base alloy is injected into the mold and the mold is cooled or permitted to cool to provide a solidified connecting rod. Equipment for injecting semi-solid aluminum alloy into the mold on a continuous basis is illustrated in U.S. Pat. No. 6,165,411, incorporated herein by reference.

After the connecting rod is formed and removed from the mold, it may be solution heat treated for purposes of solutionizing soluble constituents such as magnesium, copper and silicon in a controlled temperature range for a given period of time, depending on the alloy. After such heat treating, the connecting rod is quenched preferably in water and artificially aged for a period of time to improve strength. The connecting may be aged to a T5 condition without the solution heat treatment Thereafter, a cap is fractured along a fracture plane in a wall defining a bore suitable as a bearing surface in the large end to provide a remateable cap having substantially identical rematchable surfaces. The cap is used to secure the large end bearing of the connecting rod to a bearing surface of an engine crank, as further described herein.

Metal alloys which can be formed into connecting rods by the semi-solid process include iron base, titanium base, magnesium base, and aluminum base alloys. That is, any metal alloy that can be provided in a semi-solid condition can be formed into the connecting rod.

Suitable aluminum alloys that can be cast and formed in accordance with the invention include hypoeutectic and hypereutectic alloys having high levels of silicon. In hypoeutectic alloys, for example, the alloy can comprise from about 2.5 to 11 wt. % silicon with preferred amounts being about 5.0 to 7.5.

In addition, the alloy can contain magnesium and titanium, incidental elements and impurities. Magnesium can range from about 0.2 to 2 wt. %, preferably 0.3 to 1.5 wt. %, the remainder aluminum, incidental elements and impurities. The amount of titanium is the conventional amount used with such alloys. The amount of titanium is normally less than 0.2 wt. % and preferably in the range of 0.01 to 0.2 wt. % as titanium only, with typical ranges being in the range of 0.05 to 0.15 wt. % and preferably 0.10 to 0.15 wt. %. In some of these casting alloys, copper can range from 0.2 to 5 wt. % for the AlCu alloys of the AA2XX series aluminum alloys. In the AA5XX series alloys (AlMg) where silicon is maintained low, e.g., less than 2.5 wt. %, magnesium can range from 2 to 10.6 wt. %. Further, in AA7XX (AlZnMg) series alloys, magnesium can range from about 0.2 to 2.4 wt. %, and zinc can range from about 2 to 8 wt. %. The ranges for AA2XX, AA3XX, AA4XX, AA5XX, AA7XX and AA8XX are provided in the “Registration Record of Aluminum Association Alloy Designations and Chemical Composition Limits for Aluminum Alloys in the Form of Castings and Ingot”, revised February 1999, and are incorporated herein by reference.

Typically, the AA2XX series comprises aluminum and about 3.5 to 11 wt. % Cu and smaller amounts of elements including manganese, magnesium, silicon and nickel, depending on the alloy, all included herein by reference as if specifically set forth. AA206, for example, includes 4.2 to 5 wt. % Cu, 0.2 to 0.5 wt. % Mn, 0.15 to 0.35 wt. % Mg, 0.15 to 0.3 wt. % Ti, the balance comprising aluminum incidental elements and impurities. The AA4XX series comprises aluminum and about 3 to 13 wt. % Si with only minor amounts of iron, copper and manganese, for example. AA443.0 comprises 4.5 to 6.0 wt. % Si, max. 0.8 wt. % Fe, max. 0.6 wt. % Cu, max. 0.5 wt. % Mn, max. 0.05 wt. % Mn, max. 0.05 wt. % Mg, max. 0.25 wt. % Cr, max. 0.5 wt. % Zn and max. 0.25 wt. % Ti, the remainder comprising aluminum. The AA8XX series comprises aluminum, silicon, copper, magnesium, nickel and tin. The AA8XX can comprise aluminum, 5.5 to 7 wt. % Sn, 0.3 to 1.5 wt. % Ni, 0.7 to 4 wt. % cu. Some of the alloys are low in silicon, e.g., max. 0.7 wt. % Si. AA850.0 comprises 0.7 wt. % max. Si and Fe each, 0.7 to 1.3 wt. % Cu, 0.1 wt. % max. Mn and Mg, 0.7 to 1.3 wt. % Ni, 5.5 to 7 wt. % Sn and max. 0.2 wt. % Ti, remainder aluminum and incidental elements and impurities.

Typical of such alloys are Aluminum Association alloys AA356 and AA357, the compositions of which are incorporated herein by reference.

In the hypoeutectic type aluminum-silicon alloys, a particularly suitable aluminum alloy comprises 2 to 9 wt. % Si, 0.3 to 1.7 wt. % Mg, 0.3 to 1.2 wt. % Cu, 0.1 to 1.2 wt. % Fe, optionally 0.01 to 2.0 wt. % Ni, 0.01 to 0.35 wt. % Cr, max. 0.2 wt. % Ti, max. 0.3 wt. % V, the balance aluminum, incidental elements and impurities. A preferred composition comprises 2.1 to 6.5 wt. % Si, 0.35 to 1.45 wt. % Mg and 0.35 to 1.2 wt. % Cu. This preferred composition has the advantage that it has a wide melting range. Typically, the alloy has a solidus temperature of about 554° C. and liquidus temperature of about 638° C.

In the hypereutectic type aluminum alloys, particularly suitable alloys are the AA390 type alloys as set forth by the Aluminum Association, noted above, and incorporated herein by reference. The hypereutectic aluminum alloy can comprise 11 to 30 wt. % Si, 0.4 to 5 wt. % Cu, 0.45 to 1.3 wt. % Mg, max. 1.5 wt. % Fe, max. 0.6 wt. % Mn, max. 2.5 wt. % Ni, up to 0.3 wt. % Sn and up to 0.3 wt. % Ti. Preferably, the alloy comprises 13 to 25 wt. % Si, 4 to 5 wt. % Cu and 0.4 to 0.7 wt. % Mg.

While the invention is particularly suitable for alloys as noted, the invention can be applied to any aluminum alloy that can be thermally transformed from a microstructure, e.g., dendritic structure, to a globular phase. Such aluminum alloys can include Aluminum Association Alloys 2XXX, 4XXX, 5XXX, 6XXX and 7XXX series incorporated herein by reference.

In the AA4XXX series wrought alloys, for example, AA4011 comprises 6.5 to 7.5 wt. % Si, 0.45 to 0.7 wt. % Mg, 0.04 to 0.2 wt. % Ti, max. 0.2 wt. % Fe and Cu, max. 0.1 wt. % Mn, 0.04 to 0.07 wt. % Be, the remainder aluminum, incidental elements and impurities. In the AA5XXX series alloys, magnesium is one of the main alloying elements, with smaller amounts of other elements, depending on the alloy. For example, AA5356 comprises 4.5 to 5.5 wt. % Mg, 0.05 to 0.2 wt. % Mn, 0.05 to 0.2 wt. % Cr, 0.06 to 0.2 wt. % Ti, with max. limitations on Si, Fe, Cu and Zn.

The preferred grain refiner is a Ti/B combination. Typically, the Ti/B grain refiner is provided in a relationship of 5% Ti and 1% B. Preferably, Ti is provided in the alloys in the range of 0.01 to 0.05 wt. % Ti, with a typical amount being about 0.02 wt. % Ti. The Ti/B grain refiner results in more uniform grain size throughout the body of metal, and further it reduces the grain size approximately 10 to 30%.

Connecting rods in accordance with the invention can be used with or without shell-beating sleeves in the large end bore. If shell-bearing sleeves are not used, then the alloy should comprise additional elements. For example, an aluminum alloy in accordance with the invention can comprise 4 to 7 wt. % Si, 0.55 to 1 wt. % Cu, 0.9 to 2 wt. % Mg, 0.1 to 1 wt. % Fe, 0.01 to 2 wt. % Ni, 0.01 to 0.25 wt. % Ti, and optionally one or more of 0.1 to 7 wt. % Sn, 0.001 to 0.2 wt. % Be, 0 to 2 wt. % Cd, 0.01 to 2 wt. % Pb and 0.01 to 2 wt. % Bi, the balance aluminum, incidental elements and impurities. In a preferred embodiment, Fe is maintained in the range of 0.1 to 0.6 wt. % and preferably 0.2 to 0.5 wt. % to favor low elongation properties. A preferred alloy comprises 4.5 to 6.0 wt. % Si, 0.6 to 0.9 wt. % Cu, 1.0 to 1.5 wt. % Mg, 0.2 to 0.4 wt. % Fe, 0.01 or 0.1 to 1.5 wt. % Ni and optionally Sn, Be, Cd, Pb or Bi as noted above. Thus, when this alloy is cast into a connecting rod in accordance with the invention, the elongation can be as high as 15% but should be less than 8% and preferably less than 5%. Typically, the elongation should be maintained in the range of 1 to 5%. Normally, the use of 0.2 to 0.6 wt. % Fe produces an elongation in the range of 1 to 5%. Typically, the connecting rod can have a grain size in the range of 50 to 250 μm. The ranges set forth in this application are meant to include all the numbers within the range as if specifically set forth.

If the semi-solid body of aluminum alloy is produced from billet as noted, the billet is preferably cast as described in my U.S. Pat. No. 5,968,292 and also described in U.S. Pat. Nos. 4,693,298; 4,598,763; and 4,693,298, incorporated herein by reference.

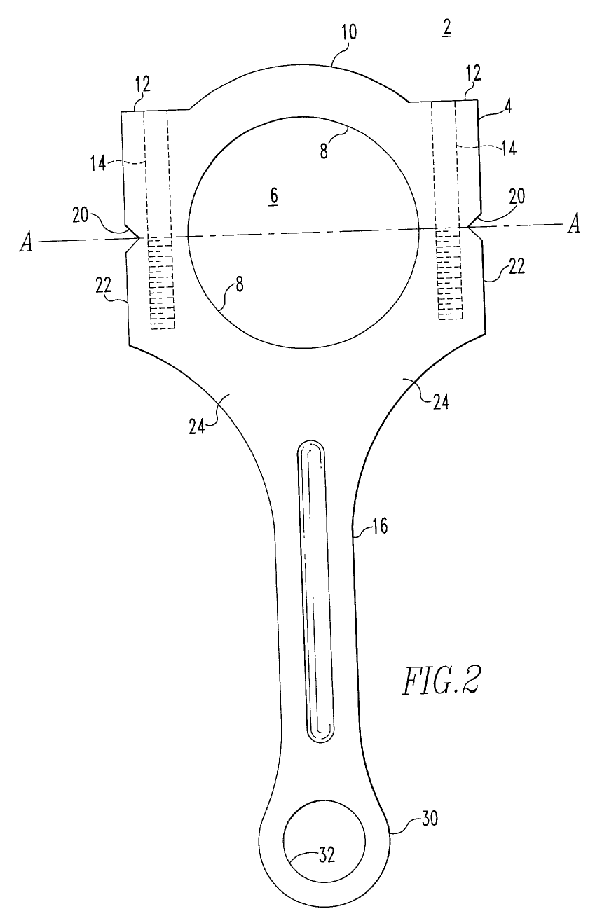

A connecting rod 2 in accordance with the invention is shown in FIG. 2. Connecting rod 2 comprises a large end 4 having a bore 6 defined by wall 8. Further, large end 4 comprises a cap portion 10 having shoulders 12. Shoulders 12 are provided for drilling and tapping to provide openings 14 (shown in outline form) for bolts to secure cap portion 10 to arm member 16 after cap portion 10 is removed by fracturing. Crevices or notches 20 in wall 22 are provided for purposes of providing a fracture plain A-A across bore 6. Connecting rod 2 further comprises arm member 16 which extends from lower portion 24 (below fracture plain A-A) to small end 30 comprising small bore 32 suitable for a wrist pin and bearing utilized for securing to a piston of an internal combustion engine.

It will be noted that crevices or notches 20 may be formed in large end 4 when the rod is cast or the crevices or notches may be machined in after casting. Further, crevices or notches 20 are illustrative and can take away form in wall 8.

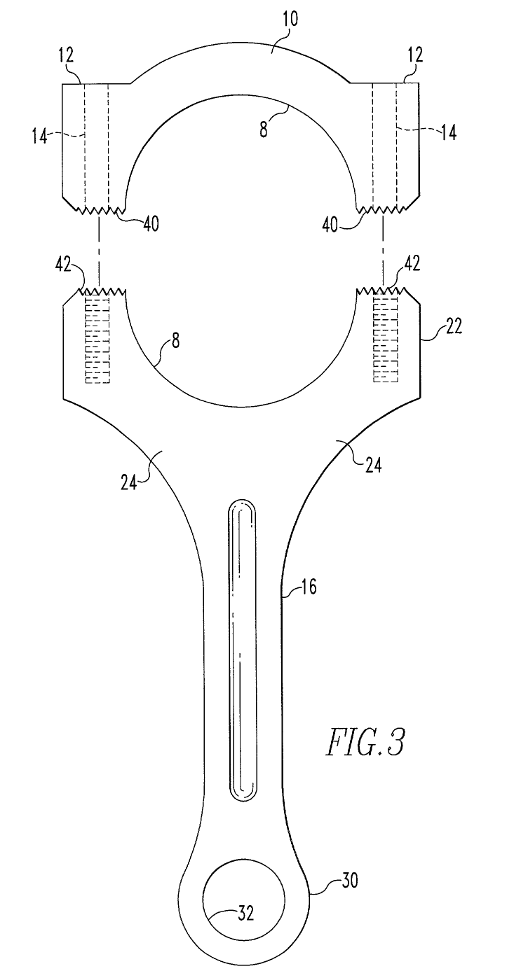

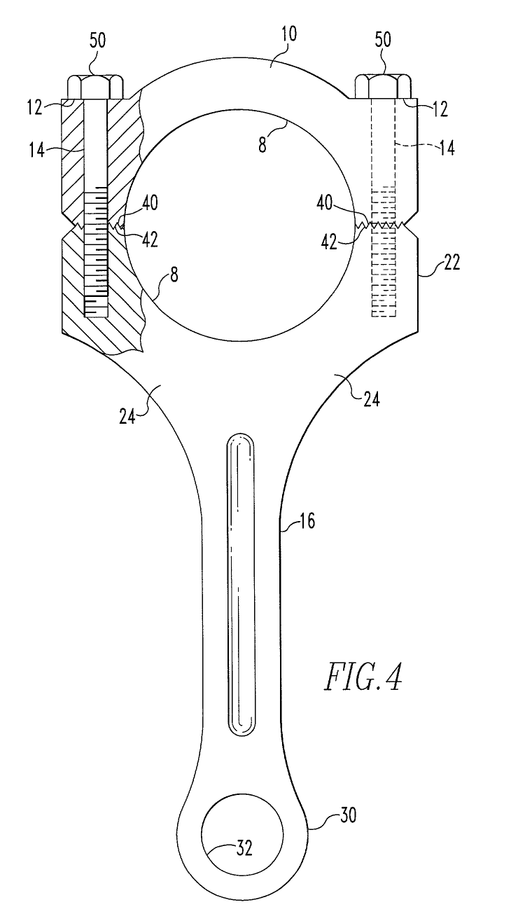

After aging, e.g., to a T5 condition, solution heat treating, quenching and aging, holes or openings 14 may be drilled and the portion of bore 14 in wall 8 below fracture plane A-A tapped or threaded to receive bolts to secure cap portion 10 after fracturing. Further, after solution heat treating, quenching and aging, cap portion 10 is fractured across fracture plane A-A to separate cap portion 10 from arm or member 16, as shown in FIG. 3. Fracturing is facilitated by the globular microstructure and provides for improved remateable surfaces 40 and 42 which are substantially exactly remateable having complementary peaks and recesses which permit the refastening of cap portion 10 to arm member 16 by bolts to provide the position or relationship of cap portion 10 to arm member 16 substantially the same as before fracturing. FIG. 4 shows cap portion 10 and arm member 16 reassembly and fastened together using bolts 50.

While it is preferred to fracture cap portion 10 after solution heat treating, quenching and aging, cap portion 10 may be fractured before solution heat treating or intermediate any of the steps of solution heat treating, quenching and aging. Further, with reference to the alloys referred to herein, it is preferred to adjust the alloy composition to favor fracturing. That is, it is preferred to use alloy compositions having low elongation properties to favor fracturing.

Fracturing of cap portion 10 can be made to occur in any manner that provides remateable surfaces 40 and 42. Apparatus and procedures for fracturing cap portion 10 across fracture plane A-A are disclosed in U.S. Pat. Nos. 5,105,538; 4,936,163; 4,860,419; and 4,569,109.

Connecting rods fabricated in accordance with the present invention are preferably solution heat treated to dissolve soluble elements such as magnesium and silicon which unite to form Mg₂Si, for example, to improve tensile properties. The solution heat treatment is preferably accomplished in a temperature range of 800°-1080° F., typically 850°-1000° F. or 1050° F. The time at temperature for solution heat treatment purposes can range from 0.1 to 12 hours. However, solution heat treatment should be controlled so as to avoid substantial loss of the globular grain structure and the redevelopment of the dendritic structure. After solution heat treatment, the connecting rods are rapidly quenched using cold water, for example, to prevent or minimize uncontrolled precipitation of the strengthening phases. Quench rates of at least 50° F. per second may be used.

After the connecting rods are quenched, they may be subject to aging treatments to improve strength. Thus, the connecting rods can be subject to underaging or overaging treatments including natural aging. The aging treatment may include multiple aging steps, including two or three aging steps. In two or more aging steps, the first step may include aging at a relatively high temperature followed by a lower temperature. Or, the first step may be relatively low followed by a relatively high aging step. In three-step aging, high and low combination aging steps may be employed. In single-step aging, the quenched connecting rod is held at a temperature in the range of 200°-450° F., preferably 300°-400° F. for a period sufficient to increase strength. Times for aging at these temperatures can range from 1 to 24 hours and typically 8 to 24 hours.

Connecting rods in accordance with the invention have improved tensile strength compared to the same alloy provided by conventional casting. That is, fabricating a connecting rod as described with respect to the invention can improve the tensile strength by 50 to 100%, depending on the alloy used. For example, tensile strengths of 40 to 50 KSI and yield strengths of 35 to 48 KSI are attainable. Comparable strengths for the same alloy provided by conventional casting ranges from 20 to 35 KSI.

The globular microstructure of the connecting rod in accordance with the invention can have a hardness of about 75 to 125 Vickers DPH hardness and the lower melting eutectic matrix can have a hardness of 100 to 175 Vickers DPH hardness.

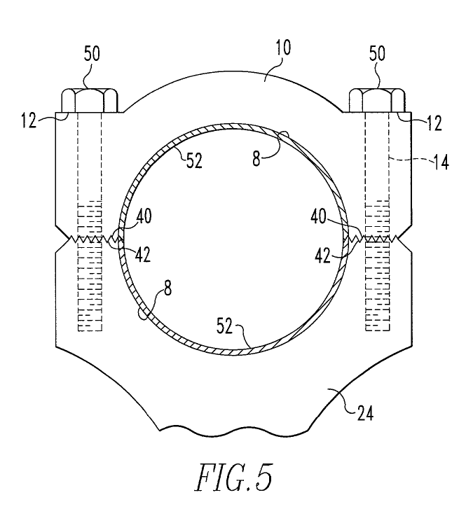

It should be noted that connecting rods fabricated in accordance with the invention can be used with or without shell-bearing sleeves. If used without shell-bearing sleeves, then the large end bore defined by wall 8 is machined to the required size or diameter for use with an engine crank. Shell bearing sleeves 52 are shown in FIG. 5 which is a partial view of the connecting rod showing the large end bore. Typically, shell-bearing sleeves 52 are semi-circular and extend from one fracture surface to the opposite fracture surface and are anchored in the bore to prevent turning during rotation of the crank.

While the invention has been described in terms of preferred embodiments, the claims appended hereto are intended to encompass other embodiments which fall within the spirit of the invention.

What is claimed is:

1. A method of forming a remateable cracked aluminum base alloy connecting rod having a globular microstructure contained in a lower melting eutectic matrix, the method comprising the steps of:
(a) providing a body of a semi-solid aluminum base alloy;
(b) providing a mold for a connecting rod, said mold defining a connecting rod having a large bore therein for use as a large bearing and a small bore for use as a small bearing, said bores connected by an arm member;
(c) injecting semi-solid aluminum base alloy into said mold;
(d) cooling said mold to solidify said semi-solid aluminum base alloy to provide said connecting rod having a globular microstructure contained in a lower melting eutectic matrix;
(e) aging said rod at a temperature of 200-400° F. for a period of about 1 to 24 hours to provide an aged rod having improved strength; and
(f) fracturing a cap portion along a fracture plane in a wall defining said large bore to provide a cap portion having cracked surfaces which permit substantially exactly rematching said cracked surfaces for securing said large bearing to a bearing surface of an engine crank.

2. The method in accordance with claim 1 wherein said aged connecting rod has an elongation not greater than 15%.

3. The method in accordance with claim 1 wherein said connecting rod in the aged condition has an elongation in the range of 1 to 5%.

4. The method in accordance with claim 1 wherein said connecting rod after solution heat treating, quenching and aging has a globular microstructure contained in a lower melting eutectic matrix.

5. The method in accordance with claim 1 including, prior to aging:
(a) solution heat treating said connecting rod at a temperature in the range of 800° to 1000° F. for a period of 0.1 to 12 hours to provide a solution heat treated connecting rod; and
(b) quenching said solution heat treated rod to provide a quenched connecting rod.

6. The method in accordance with claim 5 wherein said quenching is a water quench.

7. The method in accordance with claim 1 wherein said aluminum alloy is comprised of 4 to 7 wt. % Si, 0.55 to 1 wt. % Cu, 0.9 to 2 wt. % Mg, 0.1 to 1 wt. % Fe, 0.01 to 2 wt. % Ni, and 0.01 to 0.25 wt. % Ti, the balance aluminum, incidental elements and impurities.

8. The method in accordance with claim 7 wherein Fe is maintained in the range of 0.2 to 0.6 wt. %.

9. The method in accordance with claim 1 wherein said alloy is comprised of 4.5 to 6 wt. % Si, 0.6 to 0.9 wt. % Cu, 1 to 1.5 wt. % Mg, 0.2 to 0.6 wt. % Fe, 0.01 to 1.5 wt. % Ni and optionally one or more of 0.1 to 7 wt. % Sn, 0.001 to 0.1 wt. % Be, 0.1 to 2 wt. % Cd, 0.1 to 2 wt. % Pb and 0.01 to 2 wt. % Bi.

10. A method of forming a remateable cracked aluminum base alloy connecting rod having improved strength, the method comprising the steps of:
(a) providing a body of a semi-solid aluminum base alloy comprised of 4 to 7 wt. % Si, 0.55 to 1 wt. % Cu, 0.9 to 2 wt. % Mg, 0.1 to 1 wt. % Fe, 0.2 to 2 wt. % Ni and 0.01 to 0.25 wt. % Ti, optionally one of the following: 0.1 to 7 wt. % Sn, 0.001 to 0.1 wt. % Be, 0.1 to 2 wt. % Cd, 0.01 to 2 wt. % pb and 0.01 to 2 wt. % Bi;
(b) providing a mold for a connecting rod, said mold defining a connecting rod having a large bore therein for use as a large bearing and a small bore for use as a small bearing, said bores connected by an arm member;
(c) injecting said semi-solid aluminum base alloy into said mold;
(d) cooling said mold to solidify said semi-solid aluminum base alloy to provide said connecting rod having a globular microstructure contained in a lower melting eutectic matrix;
(e) aging said rod to provide an aged rod having improved strength and having an elongation of not greater than 6% to promote fracturing; and
(f) fracturing a cap portion along a fracture plane in a wall defining said large bore to provide a cap portion having cracked surfaces which permit substantially exactly rematching said cracked surfaces for securing said large bearing to a bearing surface of an engine crank.

11. The method in accordance with claim 10 wherein prior to aging, said rod is:
(a) solution heat treated at a temperature in the range of 800° to 1000° F. for a period of 0.1 to 12 hours followed by quenching; and
(b) quenched and solution heat treated to provide a quenched connecting rod.

12. A method of forming a remateable cracked aluminum base alloy connecting rod having improved strength, the method comprising the steps of:
(a) providing a body of a semi-solid aluminum base alloy comprised of 4 to 7 wt. % Si, 0.55 to 1 wt. % Cu, 0.9 to 2 wt. % Mg, 0.1 to 1 wt. % Fe, 0.01 to 2 wt. % Ni and 0.01 to 0.25 wt. % Ti, optionally one of the following: 0.1 to 7 wt. % Sn, 0.001 to 0.1 wt. % Be, 0.1 to 2 wt. % Cd, 0.01 to 2 wt. % Pb and 0.01 to 2 wt. % Bi;
(b) providing a mold for a connecting rod, said mold defining a connecting rod having a large bore therein for use as a large bearing and a small bore for use as a small bearing, said bores connected by an arm member;
(c) injecting said semi-solid aluminum base alloy into said mold;
(d) cooling said mold to solidify said semi-solid aluminum base alloy to provide said connecting rod having a globular microstructure contained in a lower melting eutectic matrix.;
(e) aging said rod to provide an aged rod having improved strength and having an elongation of not greater than 6% to promote fracturing; and
(f) fracturing a cap portion along a fracture plane in a wall defining said large bore to provide a cap portion having cracked surfaces which permit substantially exactly rematching said cracked surfaces for securing said large bearing to a bearing surface of an engine crank.

13. The method in accordance with claim 12 wherein said rod is solution heat treated and quenched prior to aging.

14. An aluminum base alloy suitable for forming in semi-solid condition into a connecting rod having a globular microstructure contained in a lower melting eutectic matrix and having a large bore therein for use as a large bearing and a small bore for use as a small bearing, the bores connected by an arm member to form said connecting rod, the alloy comprised of 4 to 7 wt. % Si, 0.55 to 1 wt. % Cu, 0.9 to 2 wt. % Mg, 0.1 to 1 wt. % Fe, 0.01 to 2 wt. % Ni, and 0.01 to 0.25 wt. % Ti, the balance aluminum, incidental elements and impurities.

15. The alloy in accordance with claim 14 wherein said aluminum alloy contains 0.2 to 0.6 wt. % Fe.

16. The alloy in accordance with claim 12 wherein said alloy is comprised of 4.5 to 6 wt. % Si, 0.6 to 0.9 wt. % Cu, 1 to 1.5 wt. % Mg, 0.2 to 0.6 wt. % Fe, 0.1 to 1.5 wt. % Ni and optionally one or more of 0.1 to 7 wt. % Sn, 0.001 to 0.1 wt. % Be, 0.1 to 2 wt. % Cd, 0.1 to 2 wt. % Pb and 0.01 to 2 wt. % Bi.

17. An aluminum base alloy comprised of 4 to 7 wt. % Si, 0.55 to 1 wt. % Cu, 0.9 to 2 wt. % Mg, 0.1 to 1 wt. % Fe, 0.01 to 2 wt. % Ni, and 0.01 to 0.25 wt. % Ti, the balance aluminum, incidental elements and impurities.

18. The alloy in accordance with claim 17 wherein said aluminum alloy contains 0.2 to 0.6 wt. % Fe.

19. The alloy in accordance with claim 17 wherein said alloy is comprised of 4.5 to 6 wt. % Si, 0.6 to 0.9 wt. % Cu, 1.0 to 1.5 wt. % Mg, 0.2 to 0.6 wt. % Fe, 0.1 to 1.5 wt. % Ni and optionally one or more of 0.1 to 7 wt. % Sn, 0.001 to 0.1 wt. % Be, 0.1 to 2 wt. % Cd, 0.1 to 2 wt. % Pb and 0.01 to 2 wt. % Bi.

20. An aluminum base alloy connecting rod for an internal combustion engine having a crank, said rod formed from a semi-solid aluminum base alloy and having:
(a) a globular microstructure contained in a lower melting eutectic matrix;
(b) a large bore therein for use as a large bearing end and a small bore for use as a small bearing, the bores connected by an arm member to form said connecting rod;
(c) a cap portion fractured along a fracture plane in a wall defining said large bore; and
(d) cracked surfaces provided on opposite ends of said cap portion and a second portion defining remainder of said large bore, said cap portion and said remainder having cracked surfaces substantially exactly rematching for securing said large bearing to a bearing surface of a crank.

21. An aluminum base alloy connecting rod in accordance with claim 20 wherein said rod has an elongation of not greater than 6%.

22. An aluminum base alloy connecting rod in accordance with claim 20 wherein said connecting rod in the aged condition has an elongation in the range of 1 to 5%.

23. An aluminum base alloy connecting rod in accordance with claim 20 wherein said rod has a tensile strength in the range of 40 to 80 KSI, yield strength in the range of 30 to 75 KSI and an elongation of 0.1 to 15%.

24. An aluminum base alloy connecting rod in accordance with claim 20 wherein said aluminum alloy is comprised of 4 to 7 wt. % Si, 0.55 to 1 wt. % Cu, 0.9 to 2 wt. % Mg, 0.1 to 1 wt. % Fe, 0.01 to 2 wt. % Ni, and 0.01 to 0.25 wt. % Ti, the balance aluminum, incidental elements and impurities.

25. An aluminum base alloy connecting rod in accordance with claim 20 wherein Fe is maintained in the range of 0.2 to 0.6 wt. %.

26. An aluminum base alloy connecting rod in accordance with claim 20 wherein said alloy is comprised of 4.5 to 6 wt. % Si, 0.6 to 0.9 wt. % Cu, 1.0 to 1.5 wt. % Mg, 0.2 to 0.6 wt. % Fe, 0.1 to 1.5 wt. % Ni and optionally one or more of 0.1 to 7 wt. % Sn, 0.001 to 0.1 wt. % Be, 0.1 to 2 wt. % Cd, 0.1 to 2 wt. % Pb and 0.01 to 2 wt. % Bi.

27. An aluminum base alloy connecting rod in accordance with claim 20 wherein said globular microstructure has a grain size in the range of 50 to 250 μm.

28. An aluminum base alloy connecting rod for an internal combustion engine having a crank, the rod formed from semi-solid aluminum base alloy, the rod comprising:
(a) 4 to 7 wt. % Si, 0.55 to 1 wt. % Cu, 0.9 to 2 wt. % Mg, 0.1 to 1 wt. % Fe, 0.01 to 2 wt. % Ni, and 0.01 to 0.25 wt. % Ti, and optionally one or more of 0.1 to 7 wt. % Sn, 0.001 to 0.1 wt. % Be, 0.1 to 2 wt. % Cd, 0.1 to 2 wt. % Pb and 0.01 to 2 wt. % Bi, the balance aluminum, incidental elements and impurities;
(b) a globular microstructure contained in a lower melting eutectic matrix;
(c) a large bore therein for use as a large bearing end and a small bore for use as a small bearing, the bores connected by an aim member to form said connecting rod;
(e) a cap portion fracture along a fracture plane in a wall defining said large bore; and
(e) cracked surfaces provided on opposite ends of said cap portion and a second portion defining remainder of said large bore, said cap portion and said remainder having cracked surfaces substantially exactly rematching for securing said large bearing to a bearing surface of a crank.

29. A rod in accordance with claim 28 wherein said rod has an elongation of not greater than 6%.

30. A rod in accordance with claim 28 wherein said connecting rod in the aged condition has an elongation in the range of 1 to 5%.

31. A rod in accordance with claim 28 wherein said alloy is comprised of 4.5 to 6 wt. % Si, 0.6 to 0.9 wt. % Cu, 1.0 to 1.5 wt. % Mg, 0.2 to 0.6 wt. % Fe, 0.1 to 1.5 wt. % Ni and optionally one or more of 0.1 to 7 wt. % Sn, 0.001 to 0.1 wt. % Be, 0.1 to 2 wt. % Cd, 0.1 to 2 wt. % Pb and 0.01 to 2 wt. % Bi.

32. A rod in accordance with claim 28 wherein Fe is maintained in the range of 0.2 to 0.6 wt. %.
